(19) United States
(12) Patent Application Publication
(10) Pub. No.: US 2019/0213020 A1
(43) Pub. Date: Jul. 11, 2019

(54) IMAGE PROVIDING DEVICE, METHOD FOR CONTROLLING IMAGE PROVIDING DEVICE, AND NON-TRANSITORY COMPUTER READABLE MEDIUM

(71) Applicant: SEIKO EPSON CORPORATION, Tokyo (JP)

(72) Inventor: Takashi NATORI, Suwa-shi (JP)

(73) Assignee: SEIKO EPSON CORPORATION, Tokyo (JP)

(21) Appl. No.: 16/242,237

(22) Filed: Jan. 8, 2019

(30) Foreign Application Priority Data
Jan. 9, 2018 (JP) 2018-001023

(51) Int. Cl. G06F 9/451; H04N 5/232; G06F 3/041; G03B 21/14; G06F 3/0484

(52) U.S. Cl. CPC G06F 9/451; H04N 5/23229; G06F 3/04842; G03B 21/14; G06F 3/0416

(57) ABSTRACT

An image providing device provides image information to a display device capable of executing predetermined processing corresponding to a position of an indicator on a display surface and first processing to display a first image used to execute the predetermined processing, on the display surface, and is capable of executing second processing to provide information representing a second image used to execute the predetermined processing to the display device, and the predetermined processing, and includes: an acceptance unit which accepts a notification that the display device is executing the first processing, from the display device; a determination unit which determines whether the image providing device is executing the second processing or not; and a control unit which causes the display device to stop the first processing, if the acceptance unit accepts the notification and the determination unit determines that the image providing device is executing the second processing.

### CROSS-REFERENCE

The entire disclosure of Japanese Patent Application No. 2018-001023, filed Jan. 9, 2018 is expressly incorporated by reference herein.

### BACKGROUND

### 1. Technical Field

The present invention relates to an image providing device, a method for controlling an image providing device, and a program.

### 2. Related Art

Various kinds of display devices that perform processing corresponding to the position of an indicator on a display surface (hereinafter also referred to as “predetermined processing”) are proposed. In the predetermined processing, for example, a line is drawn on the display surface according to the position of the indicator. The display device displays an operation image used to execute the predetermined processing, on the display surface. The operation image is, for example, at least one of an image of a pointer showing the distal end position of the indicator as the position of the indicator and an image of a menu bar for assisting the execution of the predetermined processing. The image of the menu bar includes, for example, a button used to execute the predetermined processing. JP-A-2013-88840 discloses a display device that can display a first image as an operation image on a display surface, and an image providing device that provides image information to the display device and can also provide information representing a second image as an operation image. When accepting image information from the image providing device, the display device regards itself as accepting the information representing the second image from the image providing device and therefore does not display the first image.

In some cases, the display device according to the related art is not accepting the information representing the second image even when accepting image information from the image providing device. In such cases, the display device according to the related art needs to display the first image but regards itself as accepting the information representing the second image from the image providing device and therefore does not display the first image. Therefore, neither the first image nor the second image is displayed. Consequently, neither the display device nor the image providing device executes the predetermined processing.

### SUMMARY

An advantage of some aspects of the invention is that, where a display device and an image providing device can execute predetermined processing corresponding to the position of an indicator on a display surface, the possibility of neither the display device nor the image providing device executing the predetermined processing is reduced.

An image providing device according to a preferred aspect (first aspect) of the invention provides image information to a display device capable of executing predetermined processing corresponding to a position of an indicator on a display surface and first processing to display a first image used to execute the predetermined processing, on the display surface, and is capable of executing second processing to provide information representing a second image used to execute the predetermined processing to the display device, and the predetermined processing. The image providing device includes: an acceptance unit which accepts a notification that the display device is executing the first processing, from the display device; a determination unit which determines whether the image providing device is executing the second processing or not; and a control unit which causes the display device to stop the first processing, if the acceptance unit accepts the notification and the determination unit determines that the image providing device is executing the second processing.

In this configuration, if the image providing device is executing the second processing, the image providing device causes the display device to stop the first processing. Therefore, the possibility of neither the display device nor the image providing device executing the predetermined processing can be reduced. Also, the possibility of both of the display device and the image providing device executing the predetermined processing can be reduced.

In a preferred example of the first aspect (second aspect), the control unit causes the display device to stop the first processing if the acceptance unit accepts the notification when the image providing device is executing the second processing.

In this configuration, the first processing is stopped if it is the case of executing the first processing in the state where the second processing is being executed. Therefore, the possibility of the situation where both of the display device and the image providing device execute the predetermined processing can be reduced. Thus, a reduction in convenience occurring in this situation can be restrained.

In a preferred example of the first aspect (third aspect), the control unit causes the display device to stop the first processing if the image providing device executes the second processing after the acceptance unit accepts the notification.

In this configuration, the first processing is stopped if it is the case of executing the second processing in the state where the first processing being executed. Therefore, the possibility of the situation where both of the display device and the image providing device execute the predetermined processing can be reduced. Thus, a reduction in convenience occurring in this situation can be restrained.

In a preferred example of the third aspect (fourth aspect), the image providing device includes an acquisition unit which acquires, from the display device, event information representing that the indicator is included in a predetermined range from the display surface, if the indicator is included in the predetermined range when the display device has stopped the first processing.

If the indicator is included in the predetermined range from the display surface when the first processing has been stopped, there is a high possibility that the display device is executing the predetermined processing corresponding to the position of the indicator. Therefore, in this configuration, by acquiring the event information from the display device, the image providing device can carry out the predetermined processing corresponding to the position of the indicator in the state where the first processing has been stopped. Thus, processing expected by the user is possible.

In a preferred example of the first aspect (fifth aspect), the image providing device includes a storage unit which stores software information representing software capable of executing the second processing, the determination unit determines that the image providing device is executing the second processing if software that is being executed on the image providing device is the software represented by the software information, and the control unit causes the display device to stop the first processing, if the acceptance unit accepts the notification and the software is being executed on the image providing device.

In this configuration, the possibility of the situation where both of the display device and the image providing device execute the predetermined processing can be reduced in the case of executing the software represented by the software information. Thus, a reduction in convenience occurring in this situation can be restrained.

In a preferred example of the first to fifth aspects (sixth aspect), the display device and the image providing device are capable of connecting to each other by first communication in which the image information is transmitted to the display device and second communication in which information other than the image information is transmitted and received between the image providing device and the display device, and the control unit instructs the display device to execute the first processing if an instruction to disconnect the second communication is accepted when the display device and the image providing device are connected to each other by the second communication.

In this configuration, the display device can execute the predetermined processing even after the second communication is disconnected. Thus, convenience can be improved.

A method for controlling an image providing device according to a preferred aspect (seventh aspect) of the invention is a method for controlling an image providing device that provides image information to a display device capable of executing predetermined processing corresponding to a position of an indicator on a display surface and first processing to display a first image used to execute the predetermined processing, on the display surface, and that is capable of executing second processing to provide information representing a second image used to execute the predetermined processing to the display device, and the predetermined processing. The method includes causing the image providing device to: accept a notification that the display device is executing the first processing, from the display device; determine whether the image providing device is executing the second processing or not; and cause the display device to stop the first processing, if the notification is accepted and it is determined that the image providing device is executing the second processing.

In this configuration, if the image providing device is executing the second processing, the image providing device causes the display device to stop the first processing. Therefore, the possibility of neither the display device nor the image providing device executing the predetermined processing can be reduced. Also, the possibility of both of the display device and the image providing device executing the predetermined processing can be reduced.

A program according to a preferred aspect (eighth aspect) of the invention is executable in an image providing device that provides image information to a display device capable of executing predetermined processing corresponding to a position of an indicator on a display surface and first processing to display a first image used to execute the predetermined processing, on the display surface, and that is capable of executing second processing to provide information representing a second image used to execute the predetermined processing to the display device, and the predetermined processing. The program causes the image providing device to: accept a notification that the display device is executing the first processing, from the display device; determine whether the image providing device is executing the second processing or not; and cause the display device to stop the first processing, if the notification is accepted and it is determined that the image providing device is executing the second processing.

In this configuration, if the image providing device is executing the second processing, the image providing device causes the display device to stop the first processing. Therefore, the possibility of neither the display device nor the image providing device executing the predetermined processing can be reduced. Also, the possibility of both of the display device and the image providing device executing the predetermined processing can be reduced.

### BRIEF DESCRIPTION OF THE DRAWINGS

The invention will be described with reference to the accompanying drawings, wherein like numbers reference like elements.

FIG. 1 shows the configuration of a display system 1 according to a first embodiment.

FIG. 2 shows an example of a PJ interactive mode.

FIG. 3 shows an example of a PC interactive mode.

FIG. 4 shows an example of the display system 1 according to the first embodiment.

FIG. 5 shows an example of a projection unit 16.

FIG. 6 is a flowchart according to the first embodiment (part 1).

FIG. 7 is a flowchart according to the first embodiment (part 2).

FIG. 8 shows an example of a display system 1 according to a second embodiment.

FIG. 9 is a flowchart according to the second embodiment (part 1).

FIG. 10 is a flowchart according to the second embodiment (part 2).

### DESCRIPTION OF EXEMPLARY EMBODIMENTS

Hereinafter, embodiments of the invention will be described with reference to the drawings. However, in the drawings, the dimension and scale of each component are made different from the actual dimension and scale, where appropriate. The embodiments described below are preferred specific examples of the invention and therefore include various technically preferable limitations. However, the scope of the invention is not limited to these embodiments unless it is specifically described below that the invention should be limited.

### First Embodiment

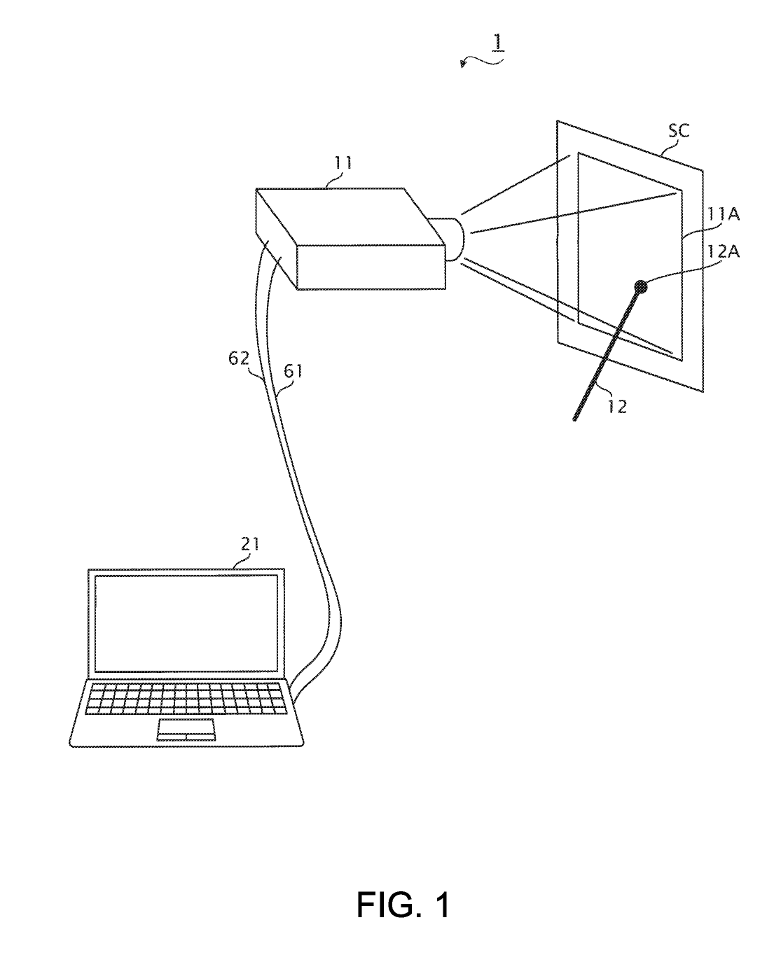

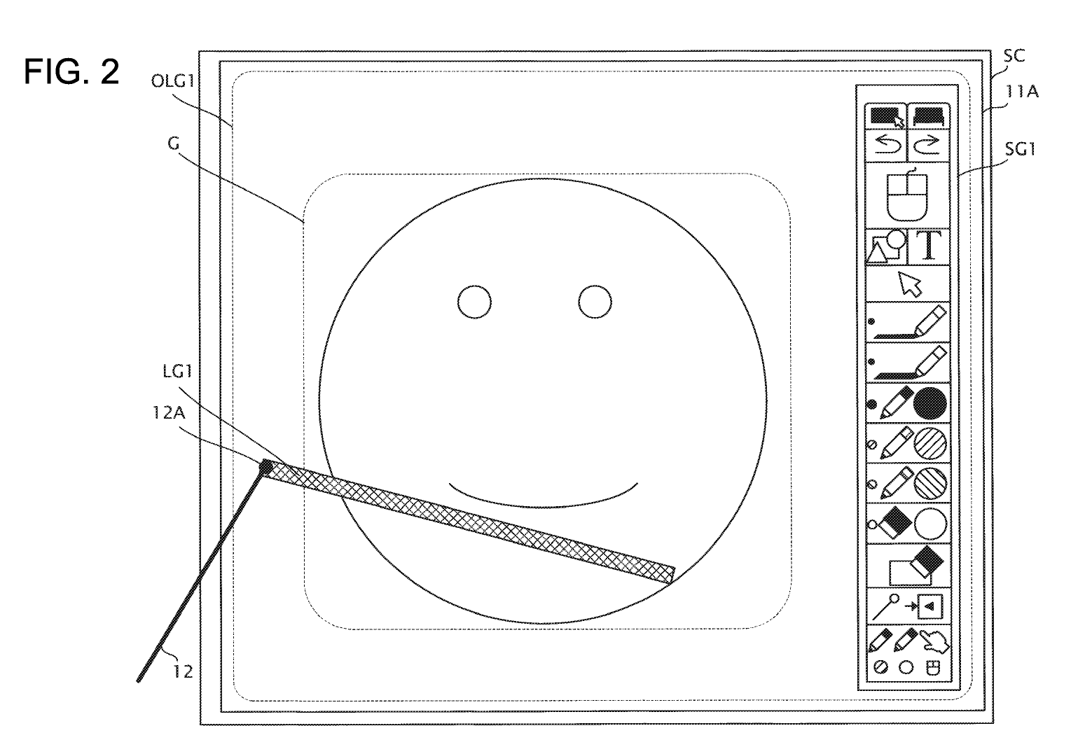

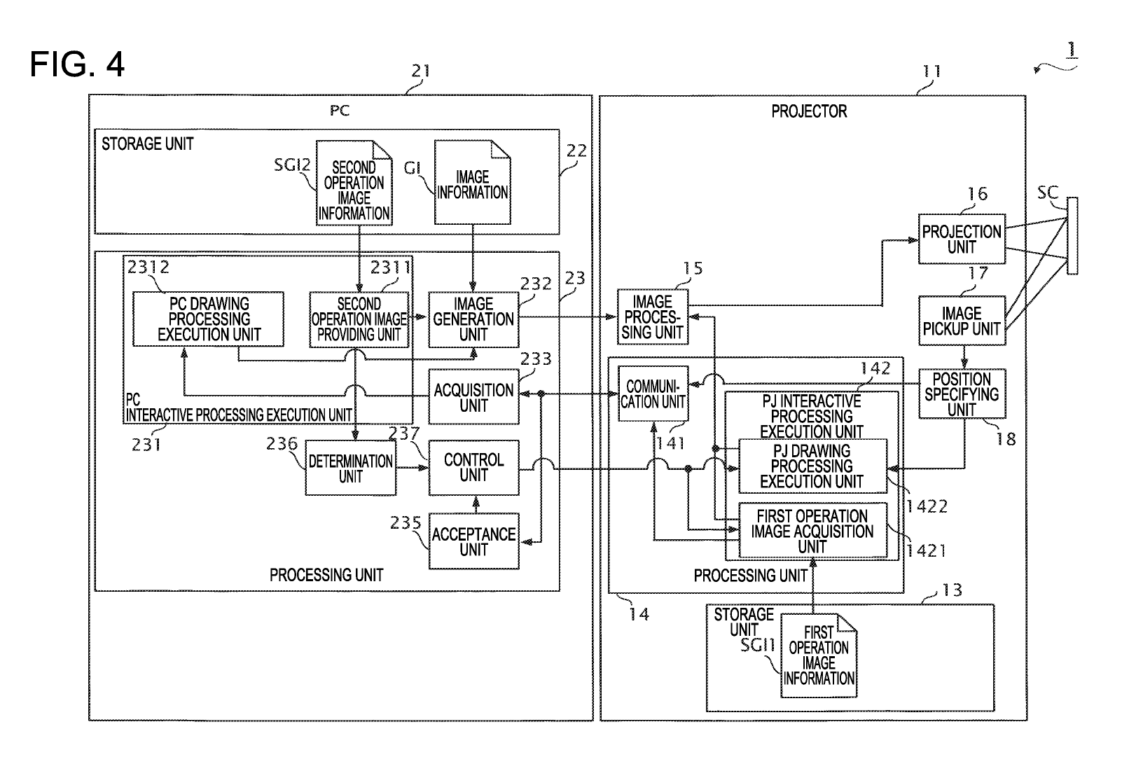

FIG. 1 shows the configuration of a display system 1 according to a first embodiment. The display system 1 includes a projector 11 (an example of a display device) and a PC (personal computer) 21 (an example of an image providing device). The projector 11 and the PC 21 can connect to each other via first communication in which the PC 21 transmits image information GI (see FIG. 4) representing an image G (see FIG. 2) as a projection target to the projector 11 and second communication in which information other than the image information GI is transmitted and received between the PC 21 and the projector 11. The first communication is carried out, for example, via a communication cable 61 such as an RGB (Red Green Blue) cable, DVI (Digital Visual Interface) cable, or HDMI (trademark registered) (High-Definition Multimedia Interface) cable. The second communication is carried out, for example, via a USB (trademark registered) (Universal Serial Bus) cable 62.

Hereinafter, the first communication is referred to as “image communication” and the second communication is referred to as “USB communication”.

The format of the image information GI is, for example, a presentation file, document file, or image file such as JPEG (Joint Photographic Experts Group).

The projector 11 projects the image represented by the image information GI received from the PC 21, onto a projection surface SC (an example of a display surface). The projection surface SC is not limited to a flat plate fixed to a wall surface and may be a wall surface itself. Here, the range where the image is projected on the projection surface SC is defined as an actual projection area 11A (available display area).

In the display system 1, while the projector 11 is projecting an image, a user holding an indicator 12 in a hand can execute a position pointing operation in the actual projection area 11A on the projection surface SC. The indicator 12 is a pen-type or stick-like operation device. The indicator 12 is used to point an arbitrary position on the projection surface SC. The projector 11 has the function of detecting the position of a distal end 12A of the indicator 12 as the position of the indicator 12 and outputs control information representing the coordinates of the detected position to the PC 21 via USB communication.

The display system 1 projects an operation image (an example of a first image and a second image) on the projection surface SC. The operation image is used to execute processing (predetermined processing) corresponding to the position of the indicator 12 on the projection surface SC. The display system 1 can execute the predetermined processing in response to an operation on the operation image. In the predetermined processing, for example, a line is drawn on the projection surface SC according to the position of the indicator 12. Hereinafter, the predetermined processing is also referred to as “drawing processing”.

The display system 1 has a PJ interactive mode and a PC interactive mode. In the first embodiment, the PJ interactive mode and the PC interactive mode do not simultaneously start in the display system 1. In the PJ interactive mode, the projector 11 executes interactive processing. In the PC interactive mode, the PC 21 executes interactive processing. The “interactive mode” described below is a general term for the PJ interactive mode and the PC interactive mode.

In the interactive processing, processing to display the operation image is executed and drawing processing corresponding to an operation on the operation image is executed. Hereinafter, to simplify the explanation, the interactive processing executed by the projector 11 is referred to as “PJ interactive processing” and the interactive processing executed by the PC 21 is referred to as “PC interactive processing”. The interactive processing described below is a general term for the PJ interactive processing and the PC interactive processing. The drawing processing executed by the projector 11 is referred to as “PJ drawing processing” and the drawing processing executed by the PC 21 is referred to as “PC drawing processing”. The drawing processing described below is a general term for the PJ drawing processing and the PC drawing processing.

In the interactive processing, for example, a line is drawn on the projection surface SC according to the position of the indicator 12. The projector 11 displays an operation image on the projection surface SC.

Hereinafter, an operation image used to execute the PJ drawing processing is referred to as “first operation image (an example of a first image)” and information representing the first operation image is referred to as “first operation image information”. Similarly, an operation image used to execute the PC drawing processing is referred to as “second operation image (an example of a second image)” and information representing the second operation image is referred to as “second operation image information”. The operation image described below is a general term for the first operation image and the second operation image.

The operation image is at least one of a pointer image showing the position of the distal end 12A as the position of the indicator 12 and an image of a menu bar for assisting the execution of the drawing processing (predetermined processing). In the description below, to simplify the explanation, it is assumed that the operation image is an image of a menu bar.

When the display system 1 executes the PJ interactive processing, the projector 11 executes first processing to project the first operation image on the projection surface SC. When the display system 1 executes the PC interactive processing, the PC 21 executes second processing to provide the second operation image information to the projector 11. Hereinafter, the first processing is referred to as “first operation image projection processing” and the second processing is referred to as “second operation image providing processing”. Thus, the projector 11 executes the first operation image projection processing and the PJ drawing processing, as the PJ interactive processing. Similarly, the PC 21 executes the second operation image providing processing and the PC drawing processing, as the PC interactive processing.

In the PC interactive mode, the PC 21 executes the second operation image providing processing and transmits, to the projector 11, overlap image information representing an overlap image in which the image represented by the image information GI and the second operation image overlap each other. The projector 11 projects the overlap image represented by the received overlap image information onto the projection surface SC and thus enables the execution of the drawing processing.

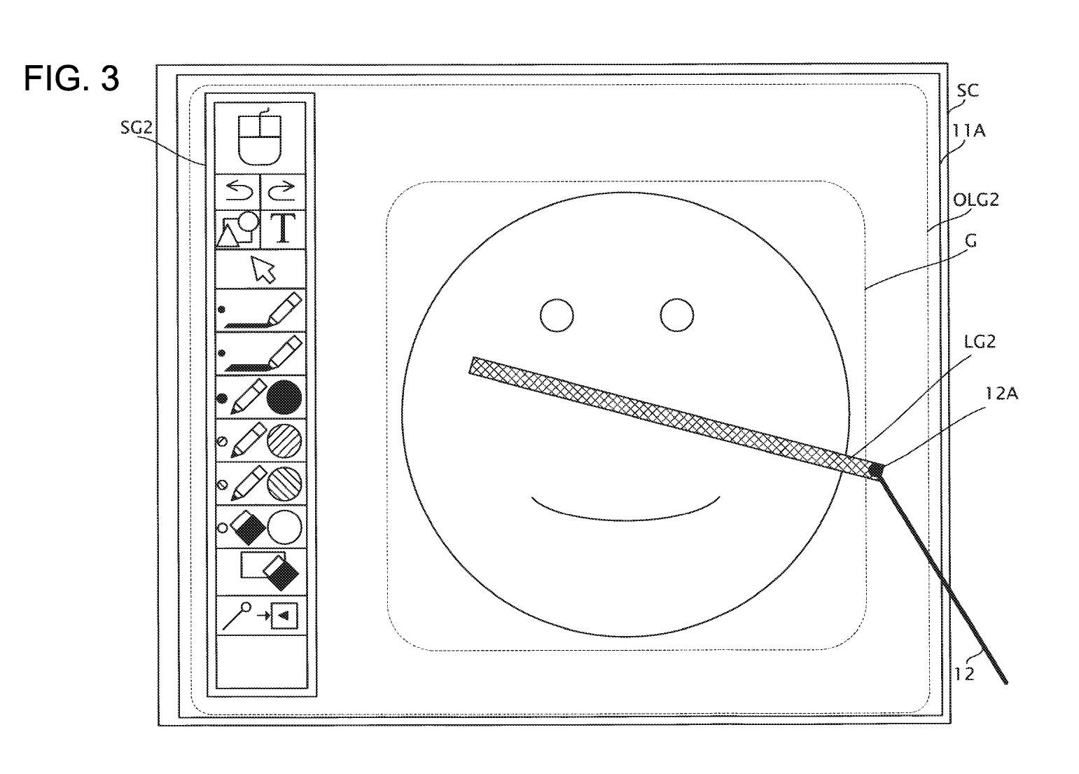

An example of the PJ interactive mode and an example of the PC interactive mode will now be described with reference to FIGS. 2 and 3.

FIG. 2 shows an example of the PJ interactive mode. As shown in FIG. 2, an overlap image OLG1 is projected in the actual projection area 11A on the projection surface SC. The overlap image OLG1 includes a first operation image SG1, an image G represented by image information GI received from the PC 21, and a line segment LG1 drawn by the PJ drawing processing. The state that precedes the state shown in FIG. 2 is first described. The projector 11 projects the image G and the first operation image SG1. The projector 11 then picks up an image of the position of the distal end 12A, specifies the position of the distal end 12A, and determines which button in the first operation image SG1 is pressed.

In the example of FIG. 2, it is assumed that a button corresponding to processing to draw a line segment corresponding to the trajectory of the distal end 12A is pressed. The projector 11 picks up an image of the position of the distal end 12A again and specifies the position of the distal end 12A. Next, the projector 11 generates image information representing the line segment LG1 corresponding to the specified position by the PJ drawing processing. Hereinafter, an image generated by the drawing processing is referred to as “operation position-related image” and image information representing the operation position-related image is referred to as “operation position-related image information”. The projector 11 then projects the overlap image OLG1, in which the image G, the line segment LG1 represented by the operation position-related image information, and the first operation image SG1 overlap each other, on the projection surface SC.

FIG. 3 shows an example of the PC interactive mode. As shown in FIG. 3, an overlap image OLG2 is projected in the actual projection area 11A on the projection surface SC. The overlap image OLG2 includes a second operation image SG2, an image G represented by image information GI, and a line segment LG2 drawn by the PC drawing processing. The state that precedes the state shown in FIG. 3 is first described. The PC 21 generates overlap image information representing an overlap image in which the second operation image SG2 and the image G overlap each other. The PC 21 transmits the overlap image information to the projector 11. The projector 11 projects the overlap image represented by the overlap image information received from the PC 21, onto the projection surface SC. As the projector 11 projects the overlap image, the second operation image SG2 is projected on the projection surface SC. The projector 11 then picks up an image of the position of the distal end 12A, specifies the position of the distal end 12A, and determines which button in the second operation image SG2 is pressed.

In the example of FIG. 3, it is assumed that a button corresponding to processing to draw a line segment corresponding to the trajectory of the distal end 12A is pressed. The projector 11 picks up an image of the position of the distal end 12A, specifies the position of the distal end 12A, and transmits the specified position to the PC 21. The PC 21 generates operation position-related image information representing the line segment LG2 corresponding to the specified position. The PC 21 then generates an overlap image in which the image G, the second operation image SG2, and the line segment LG2 represented by the operation position-related image information overlap each other. The PC 21 transmits the generated overlap image information to the projector 11. The projector 11 projects the overlap image OLG2 represented by the received overlap image information onto the projection surface SC.

As shown in FIGS. 2 and 3, the first operation image SG1 and the second operation image SG2 look similar to each other and the PJ interactive processing and the PC Interactive processing are similar to each other in terms of how to operate. Therefore, the PJ interactive mode and the PC interactive mode are similar to each other. In terms of functions, generally, in the PJ interactive mode, the projector 11 does not save the operation position-related image as temporary information. Meanwhile, in the PC interactive mode, the PC 21 can reuse the operation position-related image by saving the operation position-related image information in an editable format or by recording and saving the trajectory of the distal end 12A.

Thus, in the first embodiment, if the PJ interactive processing and the PC interactive processing are about to be executed simultaneously, the PC interactive processing with higher functions than the PJ interactive processing is executed and the PJ interactive processing is not executed.

FIG. 4 shows an example of the display system 1 according to the first embodiment. The projector 11 and the PC 21 will now be described with respect to the PJ interactive mode, the PC interactive mode, and the control of the interactive modes.

### PJ Interactive Mode

The case where the display system 1 is in the PJ interactive mode will be described. The projector 11 in the first embodiment includes a storage unit 13, a processing unit 14, an image processing unit 15, a projection unit 16, an image pickup unit 17, and a position specifying unit 18.

The storage unit 13 is a computer-readable recording medium. The storage unit 13 is, for example, a flash memory, which is a kind of non-volatile memory. The storage unit 13 is not limited to a flash memory and can be suitably changed. The storage unit 13 stores first operation image information SGI1 and a program for the projector 11 executed by the processing unit 14.

The processing unit 14 is a computer such as a CPU (central processing unit). The processing unit 14 reads and executes the program for the projector 11 stored in the storage unit 13 and thus implements a communication unit 141 and a PJ interactive processing execution unit 142. The PJ interactive processing execution unit 142 includes a first operation image acquisition unit 1421 and a PJ drawing processing execution unit 1422. The processing unit 14 may be made up of one or a plurality of processors. The one or plurality of processors forming the processing unit 14 may implement the communication unit 141 and the PJ interactive processing execution unit 142. Also, one or a plurality of processors may implement the image processing unit 15. The results of processing by the communication unit 141 and the PJ interactive processing execution unit 142 are stored in the storage unit 13.

When the display system 1 is in the PJ interactive mode, the PJ interactive processing execution unit 142 executes the PJ interactive processing. Specifically, the first operation image acquisition unit 1421 included in the PJ interactive processing execution unit 142 acquires the first operation image information SGI1 and transmits the first operation image information SGI1 to the image processing unit 15.

The image processing unit 15 performs image processing of the accepted image information and generates image information representing a projection image to be projected on the projection surface SC. For example, the image processing unit 15 generates overlap image information representing an overlap image in which the image G represented by the image information GI and the first operation image SG1 overlap each other, based on the image information GI accepted from the PC 21 and the first operation image information SGI1 accepted from the first operation image acquisition unit 1421.

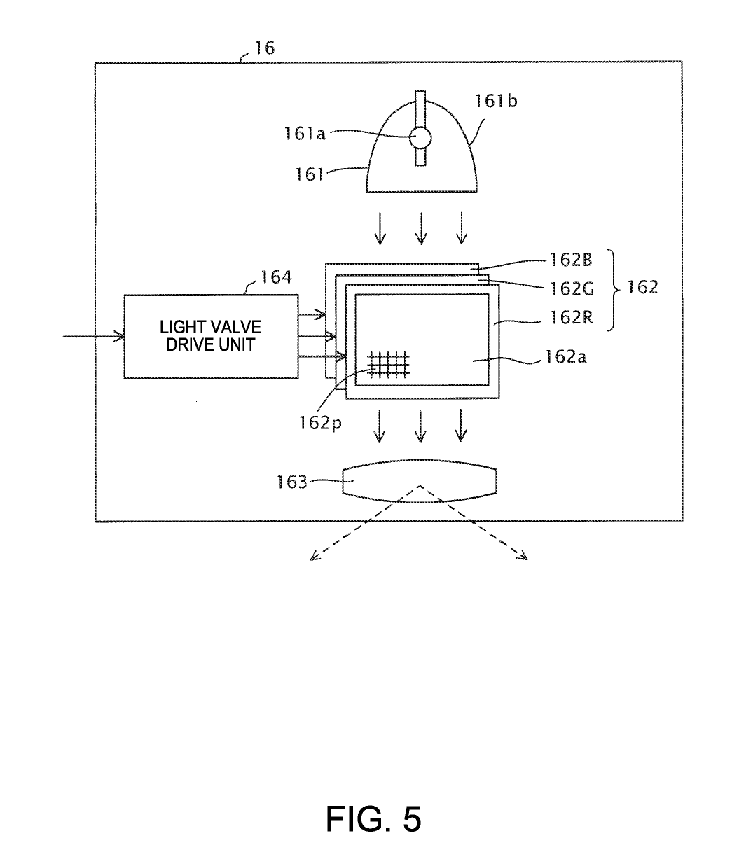

The projection unit 16 projects the projection image represented by the image information generated by the image processing unit 15 onto the projection surface SC. The configuration of the projection unit 16 will be described with reference to FIG. 5.

FIG. 5 shows an example of the projection unit 16. The projection unit 16 includes a light source 161, three liquid crystal light valves 162 (162R, 162G, 162B) as an example of a light modulation device, a projection lens 163 as an example of a projection system, a light valve drive unit 164, and the like. In the projection unit 16, the liquid crystal light valves 162 modulate light emitted from the light source 161 and thus form an image (image light), and the image is projected as enlarged via the projection lens 163. The image displayed on the projection surface SC.

The light source 161 includes a light source unit 161a made up of a xenon lamp, ultra-high-pressure mercury lamp, LED, or laser light source or the like, and a reflector 161b which reduces variation in the direction of light radiated from the light source unit 161a. The light emitted from the light source 161 has its luminance distribution variation reduced by an optical integration system, not illustrated, and is then split into color light components of red (R), green (G), and blue (B), which are the primary colors of light, by a color separation system, not illustrated. The R, G, B color light components become incident on the corresponding liquid crystal light valves 162R, 162G, 162B.

Each of the liquid crystal light valves 162 is made up of a liquid crystal panel having a pair of transparent substrates with a liquid crystal sealed between them. In the liquid crystal light valve 162, a rectangular pixel area 162a made up of a plurality of pixels 162p arranged in the form of a matrix is formed. In the liquid crystal light valve 162, a drive voltage can be applied to the liquid crystal at each pixel 162p. As the light valve drive unit 164 applies a drive voltage corresponding to image information representing an image to be projected on the projection surface SC, to each pixel 162p, each pixel 162p is set to a light transmittance corresponding to the image information. Thus, the light emitted from the light source 161 is transmitted through the pixel area 162a and thus modulated, and forms an image corresponding to the image information to be projected on the projection surface SC, for each color light component.

The description goes back to FIG. 4.

The image pickup unit 17 picks up an image of the actual projection area 11A. The actual projection area 11A includes the image projected by the projection unit 16. The actual projection area 11A may also include the indicator 12. The image pickup unit 17 transmits picked-up image information representing the picked-up image to the position specifying unit 18. For the picked-up image information, the following two formats are used. The first format is the RGB format or YUV format. The second format is only the luminance component (Y) of the YUV format.

The light which the image pickup unit 17 can pick up an image of includes the following two forms. The light in the first form is visible light. The light in the second form is invisible light such as infrared light. If the image pickup unit 17 can pick up an image of invisible light, the indicator 12 comes in the following two forms. The indicator 12 in the first form emits invisible light. The image pickup unit 17 picks up an image of the invisible light emitted from the indicator 12. The indicator 12 in the second form has a reflection part that can reflect invisible light. The projector 11 reflects invisible light to the projection surface SC. The image pickup unit 17 picks up an image of the invisible light reflected by the reflection part of the indicator 12.

The position specifying unit 18 specifies the position of the distal end 12A, based on the picked-up image information obtained from the image pickup unit 17. Specifically, the position specifying unit 18 specifies two-dimensional coordinates indicating the position of the distal end 12A on the projection surface SC, based on the picked-up image information. The position specifying unit 18 also specifies an event related to the indicator 12, based on whether the distal end 12A is in contact with the projection surface SC (an example of that “the indicator is included in a predetermined range from the display surface”) or not. The event related to the indicator 12 includes, for example, a pen-down event and a pen-up event. The pen-down event indicates that the distal end 12A is in contact with the projection surface SC. The event information representing the pen-down event includes position information representing the specified position of the distal end 12A, that is, the position where the distal end 12A is in contact with the projection surface SC. The pen-up event indicates that the distal end 12A in contact with the projection surface SC up to this point is moved away from the projection surface SC. The event information representing the pen-up event includes position information representing the position of the distal end 12A, that is, the position where the distal end 12A is moved away from the projection surface SC.

The position specifying unit 18 transmits the event information representing the specified event to the PJ drawing processing execution unit 1422 when the display system 1 is in the PJ interactive mode. The position specifying unit 18 transmits the event information to the communication unit 141 when the display system 1 is in the PC interactive mode. The description about the case where the display system 1 is in the PJ interactive mode continues below.

The PJ drawing processing execution unit 1422 executes the PJ drawing processing, based on the event specified by the position specifying unit 18. For example, the PJ drawing processing execution unit 1422 generates operation position-related image information which represents a line segment from the position of a pen-down event to the position of a pen-up event. The PJ drawing processing execution unit 1422 transmits the generated operation position-related image information to the image processing unit 15. The image processing unit 15 generates overlap image information representing an overlap image in which the image G, the first operation image SG1, and the operation position-related image overlap each other, based on the image information GI, the first operation image information SGI1, and the operation position-related image information. The image processing unit 15 transmits the generated overlap image information to the projection unit 16. Thus, the operation position-related image is displayed on the projection surface SC.

As described above, in the PJ interactive mode, the first operation image acquisition unit 1421 acquires the first operation image information SGI1. The image processing unit 15 generates overlap image information representing an overlap image including the first operation image SG1. The projection unit 16 projects the overlap image represented by the overlap image information. Thus, the first operation image projection processing is executed by the collaboration of the first operation image acquisition unit 1421, the image processing unit 15, and the projection unit 16. The execution of the first operation image projection processing enables the display system 1 to execute the PJ interactive processing. Also, the PJ drawing processing execution unit 1422 executes the PJ drawing processing.

### PC Interactive Mode

The case where the display system 1 is in the PC interactive mode will now be described. The PC 21 in the first embodiment includes a storage unit 22 and a processing unit 23.

The storage unit 22 is a computer-readable recording medium. The storage unit 22 is, for example, a flash memory, which is a kind of non-volatile memory. The storage unit 22 is not limited to a flash memory and can be suitably changed. The storage unit 22 stores image information GI, second operation image information SGI2, and a program for the PC 21 executed by the processing unit 23.

The processing unit 23 is a computer such as a CPU. The processing unit 23 reads and executes the program for the PC 21 stored in the storage unit 22 and thus implements a PC interactive processing execution unit 231, an image generation unit 232, an acquisition unit 233, an acceptance unit 235, a determination unit 236, and a control unit 237. The PC interactive processing execution unit 231 includes a second operation image providing unit 2311 and a PC drawing processing execution unit 2312. The processing unit 23 may be made up of one or a plurality of processors. The one or plurality of processors forming the processing unit 23 may implement the PC interactive processing execution unit 231, the image generation unit 232, the acquisition unit 233, the acceptance unit 235, the determination unit 236, and the control unit 237. The results of processing by the PC interactive processing execution unit 231, the image generation unit 232, the acquisition unit 233, the acceptance unit 235, the determination unit 236, and the control unit 237 are stored in the storage unit 22.

The PC interactive processing execution unit 231, the image generation unit 232, the acquisition unit 233, the acceptance unit 235, the determination unit 236, and the control unit 237 are implemented, for example, by reading and executing an application software (hereinafter referred to “app”) program. In the first embodiment, the app is, for example, a specific app developed by the manufacturer of the projector 11. The specific app generates image information GI in response to an operation or the like by the user and stores the image information GI in the storage unit 22. For example, if the specific app is presentation software, the image information GI is a presentation file.

When the display system 1 is in the PC interactive mode, the PC interactive processing execution unit 231 executes the PC interactive processing. Specifically, the second operation image providing unit 2311 included in the PC interactive processing execution unit 231 acquires the second operation image information SGI2 and provides the second operation image information SGI2 to the image generation unit 232.

The image generation unit 232 generates overlap image information representing an overlap image in which the image G and the second operation image SG2 overlap each other, based on the image information GI and the second operation image information SGI2. The image generation unit 232 transmits the generated overlap image information to the projector 11 via image communication. The image processing unit 15 performs image processing of the overlap image information generated by the image generation unit 232 and generates image information representing a projection image to be projected on the projection surface SC. The projection unit 16 projects the projection image on the projection surface SC. Thus, the second operation image SG2 is projected on the projection surface SC. The image pickup unit 17 picks up an image of the actual projection area 11A. The position specifying unit 18 specifies the position of the distal end 12A.

As described above, the position specifying unit 18 transmits the event information representing the specified event to the communication unit 141 when the display system 1 is in the PC interactive mode. The communication unit 141 transmits the event information to the PC 21 via USB communication.

The acquisition unit 233 transmits the event information accepted from the communication unit 141 to the PC drawing processing execution unit 2312. The PC drawing processing execution unit 2312 executes the PC drawing processing, based on the event represented by the event information acquired by the acquisition unit 233. For example, the PC drawing processing execution unit 2312 generates operation position-related image information that represents a line segment from the position of a pen-down event to the position of a pen-up event. The PC drawing processing execution unit 2312 transmits the generated operation position-related image information to the image generation unit 232. The image generation unit 232 generates overlap image information representing an overlap image in which the image G, the second operation image SG2, and the operation position-related image overlap each other, based on the image information GI, the second operation image information SGI2, and the operation position-related image information. The image generation unit 232 transmits the generated overlap image information to the projector 11 via image communication. The image processing unit 15 performs image processing of the overlap image information generated by the image generation unit 232 and generates image information representing a projection image to be projected on the projection surface Sc. The projection unit 16 projects the projection image on the projection surface SC. Thus, the operation position-related image is projected on the projection surface SC.

As described above, in the PC interactive mode, the second operation image providing unit 2311 provides the second operation image information SGI2 to the projector 11 and thus enables the display system 1 to execute the PC interactive processing. Also, the PC drawing processing execution unit 2312 executes the PC drawing processing.

### Control of Interactive Modes

The control of the PJ interactive mode and the PC interactive mode will now be described. The communication unit 141 transmits an execution-in-progress notification that the execution of the first operation image projection processing is in progress, to the acceptance unit 235 via USB communication. For example, the communication unit 141 transmits the execution-in-progress notification to the acceptance unit 235 when the first operation image acquisition unit 1421 has acquired the first operation image information SGI1 from the storage unit 13. The acceptance unit 235 accepts the execution-in-progress notification from the communication unit 141.

The determination unit 236 determines whether the execution of the PC interactive processing is in progress or not. The state where the execution of the PC interactive processing is in progress is described as “execution-in-progress state”. For example, if a specific app starts and the second operation image providing unit 2311 acquires the second operation image information SGI2, the determination unit 236 determines that it is the execution-in-progress state.

The control unit 237 transmits an instruction to stop the PJ interactive processing to the projector 11 via USB communication, if the acceptance unit 235 accepts the execution-in-progress notification and the determination unit 236 determines that it is the execution-in-progress state. On accepting an instruction to stop the PJ interaction processing, the first operation image acquisition unit 1421 stops acquiring the first operation image information SGI1. As the acquisition of the first operation image information SGI1 is stopped, the first operation image projection processing is stopped. Similarly, if the PJ drawing processing execution unit 1422 is executing the PJ drawing processing at this point, the PJ drawing processing execution unit 1422 ends the PJ drawing processing.

For example, the control unit 237 causes the projector 11 to stop the PJ interactive processing if the acceptance unit 235 accepts the execution-in-progress notification in the state where the determination unit 236 has determined that it is the execution-in-progress state. The case where the acceptance unit 235 accepts the execution-in-progress notification in the state where the determination unit 236 has determined that it is the execution-in-progress state is, for example, where the projector 11 starts the PJ interactive processing in the state where a specific app is executed and where the display system 1 is in the PC interactive mode.

The control unit 237 also causes the projector 11 to stop the first operation image projection processing if the determination unit 236 determines that it is the execution-in-progress state in the state where the acceptance unit 235 has accepted the execution-in-progress notification. If the execution of the PJ drawing processing is in progress, the control unit 237 also stops the PJ drawing processing. The case where the determination unit 236 determines that it is the execution-in-progress state in the state where the acceptance unit 235 has accepted the execution-in-progress notification is, for example, where a specific app starts in the state where the display system 1 is in the PJ interactive mode.

If the determination unit 236 determines that it is the execution-in-progress state in the state where the acceptance unit 235 has accepted the execution-in-progress notification, the execution of the PJ interactive processing is in progress. Therefore, the user may be operating the indicator 12 and may be in the middle of a series of operations after specifying a pen-down event and before specifying a pen-up event. The case where it is after specifying a pen-down event and before specifying a pen-up event is where the distal end 12A is in contact with the projection surface SC. If the distal end 12A is in contact with the projection surface SC, the user expects the operation of the indicator 12 to result in drawing.

To complete the drawing processing corresponding to the series of operations, the communication unit 141 transmits pseudo pen-down event information to the acquisition unit 233 if the distal end 12A is in contact with the projection surface SC when the control unit 237 has stopped the first operation image projection processing. The position of the event represented by the pseudo pen-down event information may be preferably the position where the pen-down event is actually specified.

The acquisition unit 233 acquires the pseudo pen-down event information from the communication unit 141. The acquisition unit 233 transmits the pseudo pen-down event information to the PC drawing processing execution unit 2312. After receiving the pseudo pen-down event information, the PC drawing processing execution unit 2312 can complete the drawing processing corresponding to the series of operations in order to accept pen-up event information based on an operation by the user.

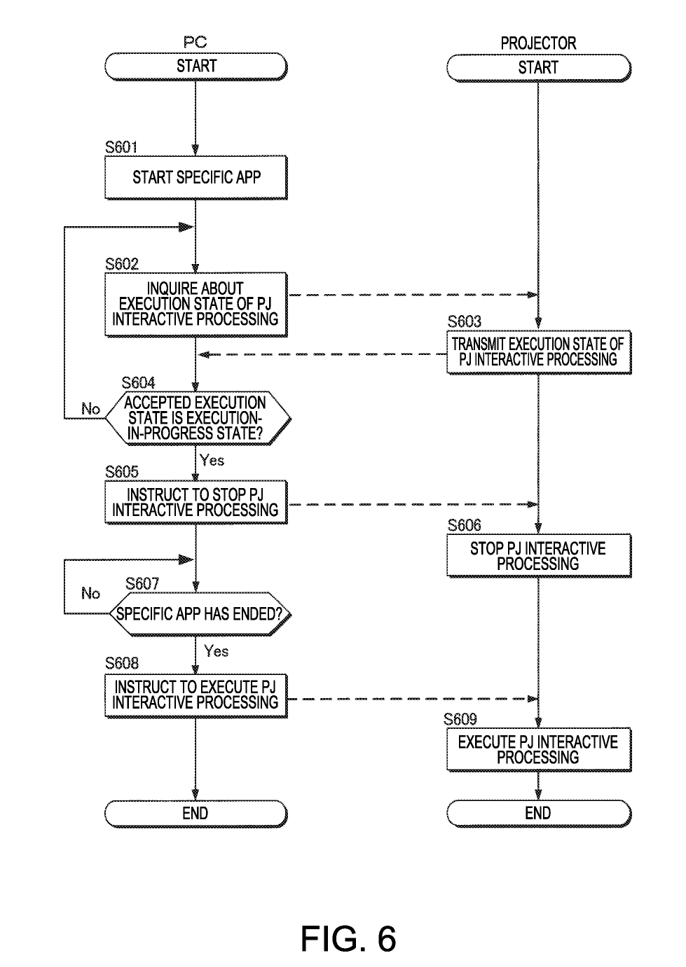

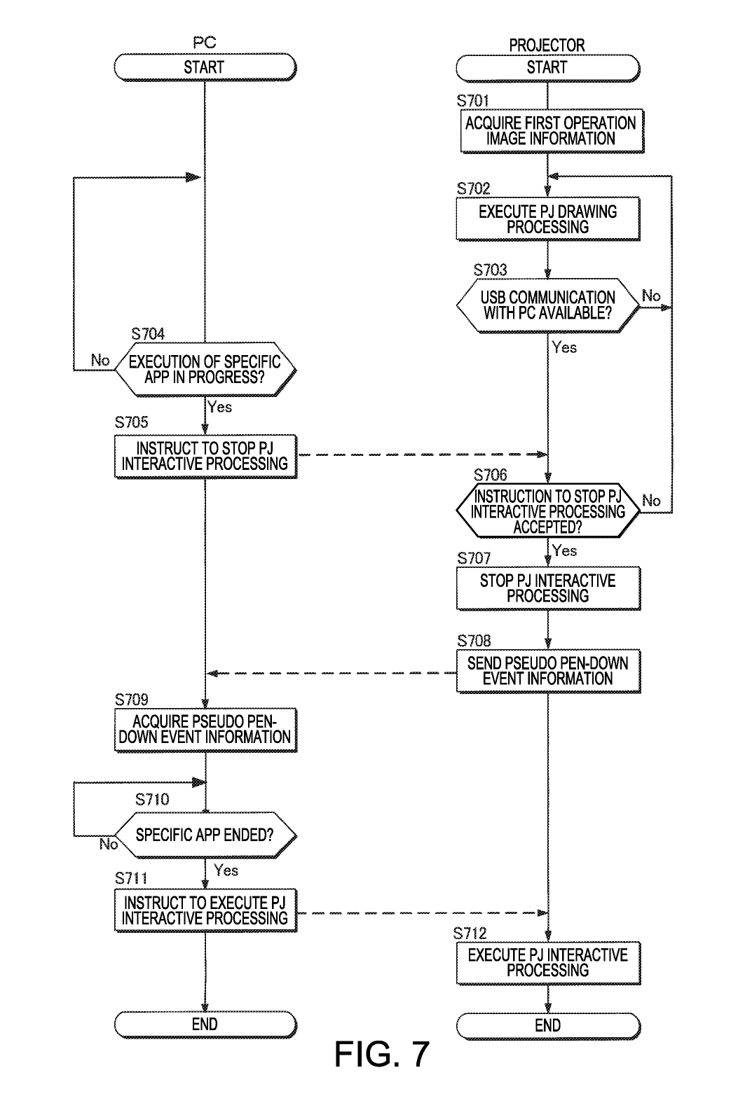

A flowchart of the display system 1 according to the first embodiment will be described with reference to FIGS. 6 and 7. The flowchart of FIG. 6 shows the case where the acceptance unit 235 accepts the execution-in-progress notification in the state where the determination unit 236 has determined that it is the execution-in-progress state, that is, the case where the projector 11 starts the PJ interactive processing in the state where a specific app is being executed. The flowchart of FIG. 7 shows the case where the determination unit 236 determines that it is the execution-in-progress state in the state where the acceptance unit 235 has accepted the execution-in-progress notification, that is, the case where a specific app starts in the state where the display system 1 is in the PJ interactive mode.

FIG. 6 is a flowchart according to the first embodiment (part 1). The processing unit 23 starts a specific app (step S601). Next, the acceptance unit 235 inquires about the execution state of the PJ interactive processing at the projector 11 via USB communication (step S602). The communication unit 141 transmits the execution state of the PJ interactive processing to the acceptance unit 235 via USB communication (step S603). Here, in the state of the display system 1 shown in FIG. 6, the startup of the PJ interactive processing is monitored. The execution of the processing by the first operation image acquisition unit 1421 can be in progress. However, the execution of the PJ drawing processing by the PJ drawing processing execution unit 1422 is not in progress because event information is not accepted yet.

The acceptance unit 235 determines whether the accepted execution state is the execution-in-progress state or not (step S604). If the accepted execution state is not the execution-in-progress state (No in step S604), the acceptance unit 235 executes the processing of step S602 again after the lapse of a predetermined time.

If the accepted execution state is the execution-in-progress state (Yes in step S604), the control unit 237 gives an instruction to stop the PJ interactive processing via USB communication (step S605). If the PJ interactive processing execution unit 142 accepts the instruction to stop, the PJ interactive processing execution unit 142 stops the PJ interactive processing (step S606). As described above, only the processing by the first operation image acquisition unit 1421 is in progress. Therefore, the first operation image acquisition unit 1421 stops acquiring the first operation image information SGI1.

After the processing of step S605 ends, the processing unit 23 determines whether the specific app has ended or not (step S607). If the execution of the specific app is in progress (No in step S607), the processing unit 23 executes the processing of step S607 again after the lapse of a predetermined time.

Meanwhile, if the specific app has ended (Yes in step S607), the control unit 237 instructs the projector 11 to execute the PJ interactive processing via USB communication (step S608). After the processing of step S608 ends, the PC 21 ends the operation shown in FIG. 6.

If the PJ interactive processing execution unit 142 accepts the instruction to execute, the PJ interactive processing execution unit 142 executes the PJ interactive processing (step S609). After the processing of step S609 ends, the projector 11 ends the operation shown in FIG. 6.

FIG. 7 is a flowchart according to the first embodiment (part 2). The first operation image acquisition unit 1421 acquires first operation image information (step S701). The PJ drawing processing execution unit 1422 executes the PJ drawing processing (step S702). Next, the communication unit 141 determines whether USB communication with the PC 21 is available or not, via USB communication (step S703). If USB communication with the PC 21 is not available (No in step S703), the communication unit 141 executes the processing of step S702 after the lapse of a predetermined time. If USB communication with the PC 21 is available (Yes in step S703), the communication unit 141 waits for an instruction from the PC 21.

The determination unit 236 determines whether the execution of a specific app is in progress or not (step S704). If the execution of the specific app is not in progress (No in step S704), the determination unit 236 executes the processing of step S704 after the lapse of a predetermined time. Meanwhile, if the execution of the specific app is in progress (Yes in step S704), the control unit 237 gives an instruction to stop the PJ interactive processing (step S705).

The PJ interactive processing execution unit 142 determines whether the instruction to stop the PJ interactive processing is accepted or not (step S706). If the instruction to stop the PJ interactive processing is not accepted (No in step S706), the PJ drawing processing execution unit 1422 executes the processing of step S702 again. Meanwhile if the instruction to stop the PJ interactive processing is accepted (Yes in step S706), the PJ interactive processing execution unit 142 stops the PJ interactive processing (step S707). If the distal end 12A is in contact with the projection surface SC, the communication unit 141 transmits pseudo pen-down event information to the PC 21 via USB communication (step S708).

The acquisition unit 233 acquires the pseudo pen-down event information from the projector 11 (step S709). The acquisition unit 233 transmits the acquired pen-down event information to the PC drawing processing execution unit 2312. After the processing of step S709, the acquisition unit 233 acquires pen-up event information in response to an operation of the indicator 12 by the user and transmits the pen-up event information to the PC drawing processing execution unit 2312. The PC drawing processing execution unit 2312 executes the PC drawing processing, based on the event represented by the accepted pen-down event information and the event represented by the pen-up event information.

After the processing of step S709 ends, the processing unit 23 determines whether the specific app has ended or not (step S710). If the execution of the specific app is in progress (No in step S710), the processing unit 23 executes the processing of step S710 again after the lapse of a predetermined time.

Meanwhile, if the specific app has ended (Yes in step S710), the control unit 237 instructs the projector 11 to execute the PJ interactive processing via USB communication (step S711). After the processing of step S711 ends, the PC 21 ends the operation shown in FIG. 7.

On accepting the instruction about execution, the PJ interactive processing execution unit 142 executes the PJ interactive processing (step S712). After the processing of step S712 ends, the projector 11 ends the operation shown in FIG. 7.

In the PC 21 and the method for controlling the PC 21 according to the first embodiment, control unit 237 causes the projector 11 to stop the PJ interactive processing, if the acceptance unit 235 accepts the execution-in-progress notification and the determination unit 236 determines that it is the execution-in-progress state. In this way, if the execution of both of the PJ interactive processing and the PC interactive processing is in progress, the PC 21 causes the projector 11 to stop the first operation image projection processing. Thus, the possibility of neither the projector 11 nor the PC 21 executing the interactive processing can be reduced. Also, the possibility of both of the projector 11 and the PC 21 executing the interactive processing can be reduced.

The PC 21 determines which of the projector 11 and the PC 21 is to execute the interactive processing, using secure information that the execution of the interactive processing is in progress, which is certain information about whether to execute the interactive processing or not. Therefore, the PC can make more accurate determination than when using information that the image information GI has been accepted, which is uncertain information that the interactive processing is not necessarily executed.

If the execution of both of the PC interactive processing and the PJ interactive processing is in progress, stopping the PJ interactive processing can restrain a reduction in convenience that occurs when interactive processing is doubly executed. With respect to the reduction inconvenience that occurs when interactive processing is doubly executed, for example, the drawing processing is assumed to be the processing of drawing a line. Based on this assumption, if both of the projector 11 and the PC 21 execute the processing of drawing a line, two lines may be drawn as a result of the drawing by the projector 11 and the PC21. As the user expects that one line will be drawn, the result of processing differs from the expected result. This reduces convenience.

Also, if the execution of both of the PC interactive processing and the PJ interactive processing is in progress, the PJ interactive processing can be stopped and the executing of the PC interactive processing can be continued. Thus, the PC interactive processing with higher functions can be executed.

The user may always understand that the PC interactive processing is in operation, if the PC 21 and the projector 11 are connected to each other via USB communication and a specific app has started. This understanding enables the user to easily specify the interactive mode of the display system 1. Enabling the user to easily specify the interactive mode of the display system 1 enables improvement in the convenience of the interactive mode.

As for the relation between the specifying and convenience of the interactive mode, the PC interactive processing and the PJ interactive processing may not have perfectly the same result and may have different results. Convenience is reduced if the result of processing differs from the result expected by the user. For example, the PJ drawing processing and the PC drawing processing, both of which are the processing of drawing a line, may result in drawing lines with different thicknesses. In this case, if the drawing processing that is not expected by the user, of the PJ drawing processing and the PC drawing processing, is executed, a line is drawn with a thickness that is not expected by the user. This reduces convenience. Also, since the PJ interactive mode and the PC interactive mode are similar to each other, as shown in FIGS. 2 and 3, the user finds it difficult to specify the current interactive mode of the display system 1, based on its appearance and how to operate.

However, in the first embodiment, the user can easily specify the interactive mode of the display system 1. Therefore, the result of processing is more likely to coincide with the result expected by the user. This can improve convenience.

In the first embodiment, the control unit 237 causes the projector 11 to stop the PJ interactive processing if the acceptance unit 235 accepts the execution-in-progress notification in the state where the determination unit 236 has determined that it is the execution-in-progress state. In this way, if the PJ interactive processing is started in the state where a specific app is executed and where the display system 1 in the PC interactive mode, the PJ interactive processing is stopped and the execution of the PC interactive processing is continued. Thus, even in the above case, double execution of interactive processing is restrained and a reduction in convenience can thus be restrained.

In the first embodiment, the projector 11 is made to stop the first operation image projection processing if the determination unit 236 determines that it is the execution-in-progress state in the state where the acceptance unit 235 has accepted the execution-in-progress notification. In this way, if a specific app is started in the state where the display system 1 is in the PJ interactive mode, the PJ interactive processing is stopped and the PC interactive processing is executed. Thus, even in the above case, double execution of interactive processing is restrained and a reduction in convenience can thus be restrained.

In the first embodiment, the acquisition unit 233 acquires pseudo pen-down event information if the distal end 12A is in contact with the projection surface SC in the state where the PJ interactive processing has been stopped from the control unit 237. As described above, the case where pseudo pen-down event information is acquired is where the PJ interactive processing has been stopped from the control unit 237 in the middle of a series of operations after a pen-down event is specified and before a pen-up event is specified. In this case, the user expects drawing to be performed by operating the indicator 12.

Thus, by acquiring the pseudo pen-down event information, it is possible to carry out the PC drawing processing corresponding to the series of operations and to perform the drawing expected by the user.

### Second Embodiment

In the first embodiment, the determination unit 236 determines whether the execution of the PC interactive processing is in progress or not, based on whether a specific app has started or not. Meanwhile, in a second embodiment, the storage unit 22 stores information specifying an app having a program that can be implemented by the PJ interactive processing execution unit 142, and the determination unit 236 determines whether the execution of the PC interactive processing is in progress or not, referring to the storage content in the storage unit 22. Also, in the second embodiment, the control unit 237 instructs the projector 11 to execute the PJ interactive processing if an instruction to disconnect USB communication is accepted. The second embodiment will now be described. In the configurations and modifications described below, elements having similar effects or functions to those in the first embodiment are denoted by the reference signs used in the first embodiment, and detailed description of such elements are omitted, where appropriate.

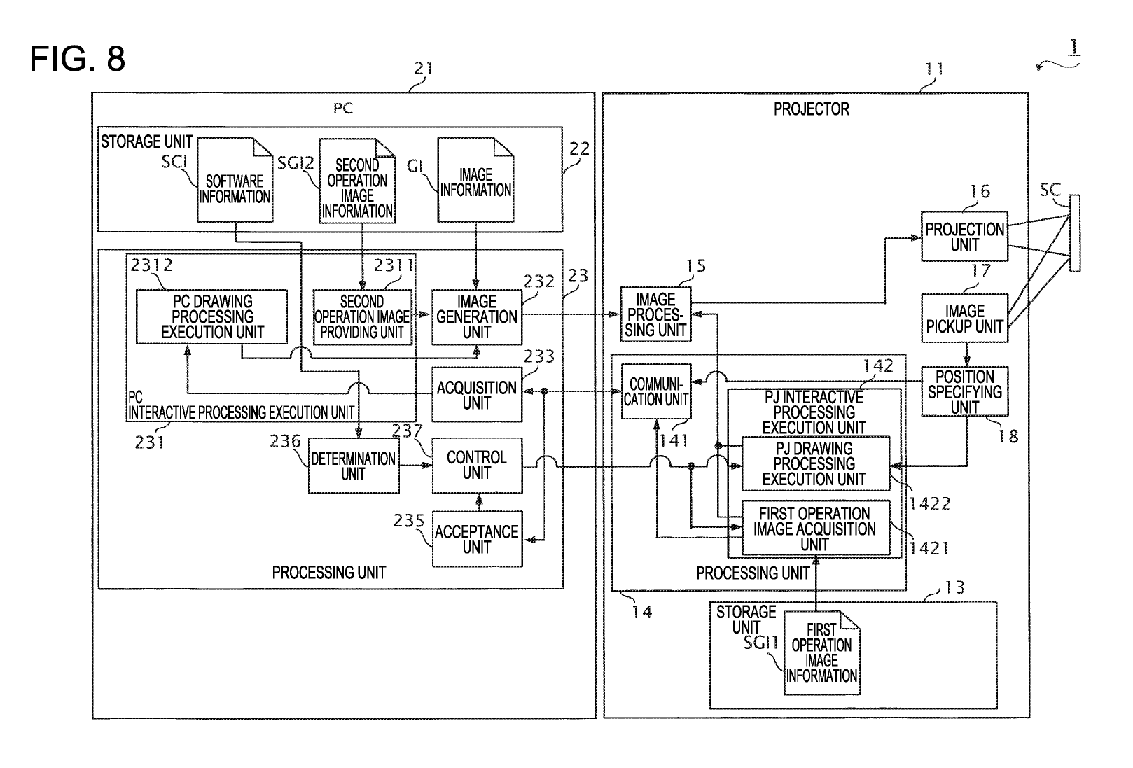

FIG. 8 shows an example of the display system 1 according to the second embodiment. Different parts from the first embodiment will be described.

The storage unit 22 also stores software information SCI. The software information SCI represents an app that can execute the PC interactive processing. For example, the software information SCI includes an ID (identifier) or name of an app that can execute the PC interactive processing.

In the second embodiment, the PC interactive processing execution unit 231, the image generation unit 232, and the acquisition unit 233 are implemented by the processing unit 23 reading and executing the program of the app represented by the software information SCI. The app represented by the software information SCI is, for example, an app developed by a third party that is different from the manufacturer of the projector 11, based on the specifications of the projector 11. This app generates image information GI in response to an operation or the like by the user and stores the image information GI in the storage unit 22. Meanwhile, the acceptance unit 235, the determination unit 236, and the control unit 237 are implemented by the processing unit 23 reading and executing the program of a resident service in the PC 21. The resident service in the PC 21 is developed, for example, by the manufacturer of the projector 11.

The determination unit 236 determines that the PC 21 is executing the PC interactive processing if the app executed on the PC 21 is the software represented by the software information SCI.

The control unit 237 instructs the projector 11 to execute the PJ interactive processing if an instruction to disconnect USB communication is accepted when the projector and the PC 21 are connected to each other via USB communication.

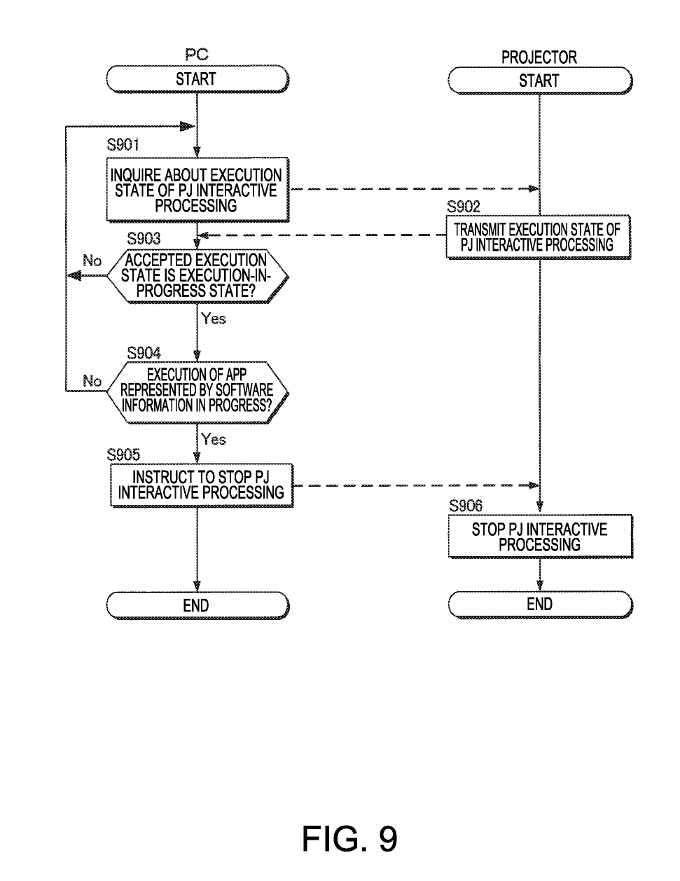

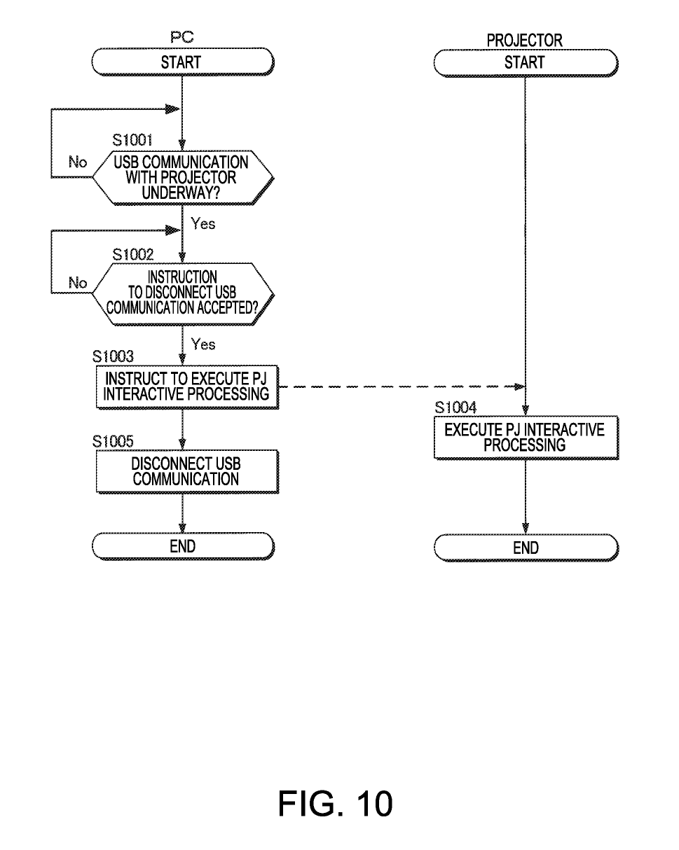

A flowchart of the display system 1 according to the second embodiment will be described with reference to FIGS. 9 and 10. The flowchart of FIG. 9 shows the case where the determination unit 236 determines that it is the execution-in-progress state in the state where the acceptance unit 235 has accepted the execution-in-progress notification, that is, the case where the app starts in the state where the display system 1 is in the PJ interactive mode. The flowchart of FIG. 10 shows the state where the instruction to disconnect USB communication is accepted in the state where the display system 1 is in the PC interactive mode.

FIG. 9 is a flowchart according to the second embodiment (part 1). The acceptance unit 235 inquires about the execution state of the PJ interactive processing at the projector 11 via USB communication (step S901). The communication unit 141 transmits the execution state of the PJ interactive processing to the acceptance unit 235 via USB communication (step S902). Here, in the state of the display system 1 shown in FIG. 9, as in the state shown in FIG. 6, the startup of the PJ interactive processing is monitored. The execution of the processing by the first operation image acquisition unit 1421 can be in progress. However, the execution of the PJ drawing processing by the PJ drawing processing execution unit 1422 is not in progress because event information is not accepted yet.

The acceptance unit 235 determines whether the accepted execution state is the execution-in-progress state or not (step S903). If the accepted execution state is not the execution-in-progress state (No in step S903), the acceptance unit 235 executes the processing of step S901 again after the lapse of a predetermined time.

If the accepted execution state is the execution-in-progress state (Yes in step S903), the determination unit 236 determines whether the execution of the app represented by the software information SCI is in progress or not (step S904). If the execution of the app represented by the software information SCI is not in progress (No in step S904), the acceptance unit 235 executes the processing of step S901 again after the lapse of a predetermined time.

Meanwhile, if the app represented by the software information SCI is in progress (Yes in step S904), the control unit 237 gives an instruction to stop the PJ interactive processing via USB communication (step S905). After the processing of step S905 ends, the PC 21 ends the operation shown in FIG. 9.

If the PJ interactive processing execution unit 142 accepts the instruction to stop, the PJ interactive processing execution unit 142 stops the PJ interactive processing (step S906). As described above, only the processing by the first operation image acquisition unit 1421 is in progress. Therefore, the first operation image acquisition unit 1421 stops acquiring the first operation image information SGI1. After the processing of step S906 ends, the projector 11 ends the operation shown in FIG. 9.

FIG. 10 is a flowchart according to the second embodiment (part 2). The control unit 237 determines whether USB communication with the projector 11 is underway or not (step S1001).

If USB communication with the projector 11 is not underway (No in step S1001), the control unit 237 executes the processing of step S1001 again after the lapse of a predetermined time. Meanwhile, if USB communication with the projector 11 is underway (Yes in step S1001), the control unit 237 determines whether an instruction to disconnect the USB communication is accepted or not, in response to an operation of the PC 21 by the user (step S1002).

If the instruction to disconnect the USB communication is not accepted (No in step S1002), the control unit 237 executes the processing of step S1002 again after the lapse of a predetermined time. Meanwhile, if the instruction to disconnect the USB communication is accepted (Yes in step S1002), the control unit 237 gives an instruction to execute the PJ interactive processing via USB communication (step S1003).

On accepting the instruction about execution, the PJ interactive processing execution unit 142 executes the PJ interactive processing (step S1004). After the processing of step S1004 ends, the projector 11 ends the operation shown in FIG. 10.

After the processing of step S1003 ends, the control unit 237 disconnects the USB communication (step S1005). After the processing of step S1005 ends, the PC 21 ends the operation shown in FIG. 10.

In the PC 21 and the method for controlling the PC 21 according to the second embodiment, the determination unit 236 determines that it is the execution-in-progress state of the PC interactive processing if the app currently executed on the PC 21 is the software represented by the software information SCI. Thus, not only in the case of executing the specific app but also in the case of executing an app capable of the PJ interactive processing that is developed by a third party, double execution of interactive processing is restrained and a reduction in convenience can thus be restrained.

In the second embodiment, the control unit 237 instructs the projector 11 to execute the PJ interactive processing if an instruction to disconnect USB communication is accepted in the state where the PC is connected via USB communication. This enables the display system 1 to execute the interactive processing even after the disconnection of the USB communication and therefore can improve convenience. Instructing the projector 11 to execute the PJ interactive processing if an instruction to disconnect USB communication is accepted in the state where the PC is connected via USB communication, can also be applied to the PC 21 in the first embodiment. For example, the processing of steps S607 and S710 can be replaced by the “processing of determining whether the specific app has ended or not, or whether an instruction to disconnect USB communication is accepted or not”. Thus, in the first embodiment, it is possible to execute the interactive processing even after the disconnection of the USB communication.

### MODIFICATIONS

Various modifications can be made to the embodiments. Specific modifications will be described below. Two or more configurations that are arbitrarily selected from the following modifications can be suitably combined together, provided that such configurations do not contradict each other. In the modifications described below, elements having similar effects or functions to those in the embodiments are denoted by the reference signs used in the foregoing description, and detailed description of these elements is omitted, where appropriate.

### First Modification

In the first embodiment, the image information GI is generated by the specific app. In the second embodiment, the image information GI is generated by the app represented by the software information SCI. That is, in the foregoing embodiments, the app that generates the image information GI and the app that executes the PC interactive processing are the same. However, these apps may be different from each other. For example, as a first modification based on the first embodiment, the storage unit 22 includes association information that represents an app associated with the specific app. For example, the user registers an app to be used simultaneously with the specific app, as association information. For example, the app represented by the association information is a document preparation app, spreadsheet app, or presentation app or the like that does not involve the PC interactive processing. The image generation unit 232 in the specific app in the first modification generates overlap image information representing an overlap image in which the second operation image SG2 overlaps the image G represented by the image information GI that is generated by the app represented by the association information.

In FIG. 6, if an app that has started is detected, the processing unit 23 determines whether this app is represented by the association information or not. If the app is represented by the association information, the processing unit 23 executes the processing of step S601.

### Second Modification

In the foregoing embodiments, as an example of the case where the indicator 12 is included within a predetermined range from the projection surface SC, it is assumed that the distal end 12A is in contact with the projection surface SC. However, this is not limiting. For example, a pen-down event may indicate that the distal end 12A is included within a predetermined range from the projection surface SC. A pen-up event may indicate that the distal end 12A is out of the predetermined range from the projection surface SC.

### Third Modification

In the foregoing embodiments, the predetermined processing is assumed to be the drawing processing but is not limited to the drawing processing. For example, the predetermined processing may be processing related to drawing. For example, the processing related to drawing is processing to change the thickness of a straight line to be drawn after this processing, or processing to change the color of a straight line to be drawn after this processing.

### Fourth Modification

In the foregoing embodiments, the second communication is assumed to be USB communication but is not limited to USB communication. For example, the second communication may be communication conforming to the IEEE (Institute of Electrical and Electronics Engineers) 1394 standard. The first communication and the second communication may be wireless communication or wired communication.

### Fifth Modification

The projection unit 16 in the foregoing embodiments uses liquid crystal light valves as a light modulation device. However, the light modulation device is not limited to liquid crystal light valves and can be suitably changed. For example, the light modulation device may have a configuration using three reflection-type liquid crystal panels. The light modulation device may also employ a system using one crystal panel, a system using three digital mirror devices (DMDs), a system using one digital mirror device, or the like. If only one liquid crystal panel or DMD is used as the light modulation device, components equivalent to the color separation system and the light combining system are not necessary. Also, other than the liquid crystal panel and DMD, any configuration that can modulate light emitted from a light source can be employed as the light modulation device.

### Sixth Modification

All or a part of the elements implemented by the processing unit 14 and the processing unit 23 executing a program may be implemented by hardware such as an electronic circuit, for example, FPGA (field programmable gate array) or ASIC (application specific IC), or may be implemented by the collaboration of software and hardware.

### Seventh Modification

While the display device in the foregoing embodiments is a projector, the display device may be any device capable of displaying an image and is not limited to a projector. For example, the foregoing embodiments can also be applied to the case where the display device is an LCD (liquid crystal display). Similarly, while the image providing device in the foregoing embodiments is a PC, the image providing device may be any device capable of providing image information and is not limited to a PC. For example, the foregoing embodiments can also be applied to the case where the image providing device is a tablet terminal or smartphone. Also, while the PC is illustrated as a laptop PC in FIG. 1, the PC may be a desktop PC.

### Eighth Modification

The invention may be configured in an aspect of a program executed by a computer provided in the PC 21 described above to achieve the functions of the PC 21 described above, a non-transitory computer readable medium on which the program is so recorded as to be readable by a computer, or a transmission medium that transmits the program. The non-transitory computer readable medium described above can be a magnetic or optical recording medium or a semiconductor memory device. Specific examples of the non-transitory computer readable medium may include a flexible disk, an HDD (hard disk drive), a CD-ROM (compact disk read only memory), a DVD (digital versatile disk), a Bluray (registered trademark) disc, a magneto-optical disk, a flash memory, and a portable recording medium, such as a card-shaped recording medium, or an immobile recording medium. The non-transitory computer readable medium described above may instead be a RAM (random access memory), a ROM (read only memory), or an HDD or any other nonvolatile storage device that is internal storage devices provided in the projector 11 or in an external apparatus connected to the projector 11.

What is claimed is:

1. An image providing device that provides image information to a display device capable of executing predetermined processing corresponding to a position of an indicator on a display surface and first processing to display a first image used to execute the predetermined processing, on the display surface, and that is capable of executing second processing to provide information representing a second image used to execute the predetermined processing to the display device, and the predetermined processing, the image providing device comprising:
an acceptance unit which accepts a notification that the display device is executing the first processing, from the display device;
a determination unit which determines whether the image providing device is executing the second processing or not; and
a control unit which causes the display device to stop the first processing, if the acceptance unit accepts the notification and the determination unit determines that the image providing device is executing the second processing.

2. The image providing device according to claim 1, wherein
the control unit causes the display device to stop the first processing if the acceptance unit accepts the notification when the image providing device is executing the second processing.

3. The image providing device according to claim 1, wherein
the control unit causes the display device to stop the first processing if the image providing device executes the second processing after the acceptance unit accepts the notification.

4. The image providing device according to claim 3, further comprising
an acquisition unit which acquires, from the display device, event information representing that the indicator is included in a predetermined range from the display surface, if the indicator is included in the predetermined range when the display device has stopped the first processing.

5. The image providing device according to claim 1, further comprising
a storage unit which stores software information representing software capable of executing the second processing,
wherein the determination unit determines that the image providing device is executing the second processing if software that is being executed on the image providing device is the software represented by the software information, and
the control unit causes the display device to stop the first processing, if the acceptance unit accepts the notification and the software is being executed on the image providing device.

6. The image providing device according to claim 1, wherein
the display device and the image providing device are capable of connecting to each other by first communication in which the image information is transmitted to the display device and second communication in which information other than the image information is transmitted and received between the image providing device and the display device,
the control unit may instruct the display device to execute the first processing if an instruction to disconnect the second communication is accepted when the display device and the image providing device are connected to each other by the second communication.

7. A method for controlling an image providing device that provides image information to a display device capable of executing predetermined processing corresponding to a position of an indicator on a display surface and first processing to display a first image used to execute the predetermined processing, on the display surface, and that is capable of executing second processing to provide information representing a second image used to execute the predetermined processing to the display device, and the predetermined processing, the method comprising causing the image providing device to:
accept a notification that the display device is executing the first processing, from the display device;
determine whether the image providing device is executing the second processing or not; and
cause the display device to stop the first processing, if the notification is accepted and it is determined that the image providing device is executing the second processing.

8. A non-transitory computer readable medium executable in an image providing device that provides image information to a display device capable of executing predetermined processing corresponding to a position of an indicator on a display surface and first processing to display a first image used to execute the predetermined processing, on the display surface, and that is capable of executing second processing to provide information representing a second image used to execute the predetermined processing to the display device, and the predetermined processing, the program causing the image providing device to:
accept a notification that the display device is executing the first processing, from the display device;
determine whether the image providing device is executing the second processing or not; and
cause the display device to stop the first processing, if the notification is accepted and it is determined that the image providing device is executing the second processing.
